(19) United States
(12) Patent Application Publication
(10) Pub. No.: US 2023/0193012 A1
(43) Pub. Date: Jun. 22, 2023

(54) Polyvinyl Chloride Bio-Plasticizer Compositions

(71) Applicant: Baerlocher USA, Dover, OH (US)

(72) Inventors: John Dallatore, Dover, OH (US); Michael W. Short, Dover, OH (US)

(73) Assignee: Baerlocher USA, Dover, OH (US)

(21) Appl. No.: 18/081,357

(22) Filed: Dec. 14, 2022

Related U.S. Application Data
(60) Provisional application No. 63/290,404, filed on Dec. 16, 2021.

(51) Int. Cl. C08L 27/06

(52) U.S. Cl. CPC C08L 27/06

(57) ABSTRACT

Plasticizer compositions are provided that include, in combination, from 30% to 99% by weight bioplasticizer and from 1% to 70% by weight of a chlorinated ester of a fatty acid, based on the total weight of the plasticizer composition. The bioplasticizer includes a vegetable-derived triglyceride or oil modified by esterification, epoxidation, or acylation. Example vegetable-derived triglyceride or oils are derived from soybean oil, palm oil, olive oil, cotton seed oil, linseed oil, safflower oil, sunflower oil, canola oil, rapeseed oil, jatropha oil, algae oil, tall oil, corn oil, tung oil, and mixtures of any two or more thereof. The chlorinated ester has a chlorine content from 2% to 60% by weight.

### CROSS-REFERENCES TO RELATED APPLICATIONS

This application claims benefit of priority to U.S. Provisional Application Serial No. 63/290,404, filed Dec. 16, 2021.

### TECHNICAL FIELD

The present disclosure relates to plasticizer compositions and materials prepared with the plasticizer compositions and, more particularly, to bioplasticizer compositions having substantial levels of plant-based components, and to materials prepared with the bioplasticizer compositions.

### SUMMARY

The present disclosure provides a plasticizer composition comprising, in combination: from 30% to 99% by weight bioplasticizer based on the total weight of the plasticizer composition, the bioplasticizer comprising a vegetable-derived triglyceride or oil modified by esterification, epoxidation, or acylation; and from 1% to 70% by weight chlorinated ester based on the total weight of the plasticizer composition, the chlorinated ester of a fatty acid, the chlorinated ester having a chlorine content from 2% to 60% by weight.

In embodiments, the vegetable-derived triglyceride or oil is derived from soybean oil, palm oil, olive oil, cotton seed oil, linseed oil, safflower oil, sunflower oil, canola oil, rapeseed oil, jatropha oil, algae oil, tall oil, corn oil, tung oil, and mixtures of any two or more thereof. The bioplasticizer may be epoxidized soybean oil.

In embodiments, the chlorinated ester is a compound according to the formula:

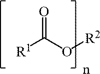

where: each R¹ is independently a (C₆-C₂₂) chlorinated hydrocarbyl; R² is a (C₁-C₁₈) hydrocarbon radical having a valence equal to subscript n; and subscript n is 1, 2, 3, or 4.

The present disclosure further provides a composition including polyvinyl chloride and a plasticizer composition, the plasticizer composition comprising, in combination: from 30% to 99% by weight bioplasticizer based on the total weight of the plasticizer composition, the bioplasticizer comprising a vegetable-derived triglyceride or oil modified by esterification, epoxidation, or acylation; and from 1% to 70% by weight chlorinated ester based on the total weight of the plasticizer composition, the chlorinated ester of a fatty acid, the chlorinated ester having a chlorine content from 2% to 60% by weight. The composition may be a plastisol having a minimum plasticizer content of 50 phr. The composition may be a flexible vinyl compound having a minimum plasticizer composition content of 20 phr.

The present disclosure further provides polyvinyl chloride articles prepared from either the plastisol or the flexible vinyl compound of the present disclosure.

The present disclosure further provides a method of preparing a polyvinyl chloride article, the method comprising: combining polyvinyl chloride resin with a plasticizer composition to obtain a flexible vinyl compound, the plasticizer composition comprising, in combination: from 30% to 99% by weight bioplasticizer based on the total weight of the plasticizer composition, the bioplasticizer comprising a vegetable-derived triglyceride or oil modified by esterification, epoxidation, or acylation; and from 1% to 70% by weight chlorinated ester based on the total weight of the plasticizer composition, the chlorinated ester of a fatty acid, the chlorinated ester having a chlorine content from 2% to 60% by weight; and fusing the flexible vinyl compound.

### DETAILED DESCRIPTION

Polyvinyl chloride (PVC) is a polymer well known for its wide range of industrial applications, but it presents natural rigidity due to its molecular structure, requiring the use of additives to increase its range of useful applications, resulting in compositions that are commonly known as PVC compounds. Among known compounds, plasticized PVC compounds present high flexibility and are used in films, wire and cable insulation, packaging, hoses, toys, etc. Plasticized PVC compounds are obtained by the addition, in different levels, of additives known as plasticizers, to provide the desired flexibility.

Plasticizers are, in general, high boiling point liquids with average molecular weight between 300 and 600, linear or cyclic carbon chains (14 to 40 carbons) that, when added to the PVC resin allow for movement between the PVC molecules promoting flexibility to the final compound. Common primary plasticizers are mainly phthalates that are obtained from petroleum. In addition to being dependent on the fluctuations of petroleum prices, phthalates are suspect of having adverse effects on human health. As a result, a search was initiated to find alternatives that are technically and economically viable to replace petroleum based plasticizers. Epoxidized soybean oil was proposed as a primary plasticizer, however, its low compatibility with PVC limited its use to small quantities, keeping it from completely replacing phthalates as a primary plasticizer.

Further concerns with selection of plasticizers for PVC include the tendency of a cured resin to yellow over time, particularly when exposed to heat or ultraviolet light. Typically, a PVC material can be assessed for heat stability and/or color hold by exposing the PVC material to a heat source with increasing temperature to determine its tendency to yellow and also the temperature point at which the PVC material chars. Most alternative plasticizers, including epoxidized soybean oils, have severe limits for producing materials resistant to yellowing over time and with exposure to heat. Accordingly, there are ongoing needs to provide plasticizer compositions that are not derived from petroleum yet still provide PVC materials with desirable levels of heat tolerance and color fastness.

PVC materials are subject to potential heat-induced instability or discoloration in two common scenarios: in-process heat exposure and post-process heat exposure. In-process heat-induced instability and/or discoloration results from high temperatures associated with processing conditions, e.g., when the PVC material is fused and in molten state and potentially subject to mechanical shear. In-process heat exposure usually causes quick discoloration, e.g., in minutes. Post-process heat-induced instability and/or discoloration, sometimes referred to as low temperature heat aging, occurs when PVC material is exposed to temperatures higher than ambient but lower than those experienced during processing. Such low temperature heat aging might occur for PVC materials in the interior of a car during the summer, for example. Discoloration resulting from post-process heat exposure usually occurs on the scale of days or weeks.

When ethoxylated bioplasticizers such as epoxidized soybean oil are used as PVC additives, the resulting PVC material typically demonstrates poor color hold. This is particularly true for highly plasticized compounds such as plastisols where there can be more plasticizer than PVC resin in the PVC compound. Therefore, most currently available bioplasticizers are not suitable as primary PVC plasticizers for many applications.

Embodiments described herein are directed to plasticizer compositions that are suitable for use as plasticizers for PVC materials while being primarily derived from bio-based materials. The plasticizer compositions include, in combination: a bioplasticizer comprising a vegetable-derived triglyceride or oil modified by esterification, epoxidation, or acylation; and a chlorinated ester of a fatty acid. It has been discovered that chlorinated esters may be combined with bioplasticizers to form plasticizer compositions that can be used to produce stable PVC materials both resistant to yellowing and primarily derived from bio-based materials. The plasticizer compositions described herein thus provide environmentally friendly alternatives to petroleum-based plasticizers and may be used to produce PVC materials exhibiting both high thermal stability and good color hold, thereby expanding the potential applications for bio-based PVC materials.

The term “polyvinyl chloride” (PVC) as used herein is intended to cover those homo-and copolymer resins of vinyl chloride known to persons of ordinary skill in the art. Generally speaking, copolymers of vinyl chloride (containing up to about 20% of such monomers as vinyl acetate, propylene, ethylene, diethyl maleate, dimethyl fumarate, and other ethylenically unsaturated monomers) are intended to be covered.

A “plastisol” is a specific type of PVC compound based on dispersion grade PVC resin. Plastisols often contain a large amount of plasticizer and are in liquid form until heated to gelation. The plasticizer compositions disclosed herein may be particularly suitable for plastisol applications because plastisols are often heated and kept in a molten state for an extended period of time while small quantities of liquid are removed and placed into a mold. One example of such plastisol use is the at-home production of PVC articles where people heat a plastisol on a stovetop and fill molds to create the PVC materials such as synthetic fishing worms. The plasticizer compositions of the present disclosure can be used to form plastisols used to produce bio-based PVC materials able to withstand the in-process and post-process heat exposures discussed above. For example, synthetic fishing worms produced using the disclosed plastisols may avoid yellowing during stovetop processing and afterwards, for example, when left in a hot tackle box during a summer day.

The plasticizer compositions of the present disclosure may also be used in yarn coating. “Yarn coating” is a form of string that is coated and then weaved into products like sunshades and awnings, which are commonly made in light colors. In part due to the light color of yarn coating, straight bio-based plasticizers do not work well because of the poor color hold typically associated with plasticized PVC materials. However, the plasticizer compositions disclosed herein provide for a way to produce bio-based yarn coating that is able to withstand low temperature aging conditions such as the prolonged exposure to sunlight experienced by sunshades and awnings.

The plasticizer compositions disclosed herein may also be used in clear flame retardant PVC films. Currently, these films are made using phosphate plasticizers that are expensive and have raised health concerns. The bioplasticizer blends disclosed herein offer a more cost-effective and environmentally friendly alternative to phosphate plasticizers for use in clear flame retardant films.

As discussed previously, embodiments herein are directed to plasticizer compositions that are suitable for use as plasticizers for polyvinyl chloride materials. The plasticizer compositions include, in combination: a bioplasticizer comprising a vegetable-derived triglyceride or oil modified by esterification, epoxidation, or acylation; and a chlorinated ester of a fatty acid. The chlorinated ester may be a chlorinated methyl ester having a chlorine content from 2% to 60% by weight.

Embodiments of the plasticizer compositions disclosed herein may contain, in combination: from 30% to 99% by weight bioplasticizer based on the total weight of the plasticizer composition, the bioplasticizer comprising a vegetable-derived triglyceride or oil modified by esterification, epoxidation, or acylation; and from 1% to 70% by weight chlorinated ester based on the total weight of the plasticizer composition.

The plasticizer compositions include a bioplasticizer. The bioplasticizer according to embodiments includes a vegetable-derived triglyceride or oil modified by esterification, epoxidation, or acylation. The bioplasticizer component will now be described according to various embodiments.

According to some embodiments, the bioplasticizer is a modified soybean oil (I.V. value about 120-143) for use as a primary plasticizer and co-thermal stabilizer in PVC resins. It should be noted, however, that soybean oil is not the only oil useful with this invention. Exemplary oils include any vegetable or plant fatty acid glyceride that is significantly unsaturated. Significantly unsaturated means that the vegetable oil typically has more than about 80% unsaturated fatty acids. Most preferably the unsaturation should be about 84% or higher. Typically the oil has an iodine value, which is a measurement of the amount of double bonds in the fatty acids of the oil, that is about 100 and higher.

Examples of other preferred oils as sources for fatty acid derivatives include: canola oil (iodine value about 100-115), corn oil (iodine value about 118-128), linseed oil (iodine value about 170-200), rapeseed oil (iodine value about 100-115), safflower oil (iodine value about 140-150), sunflower oil (iodine value about 125-140), tall oil (iodine value about 140-190), and tung oil (iodine value about 180) (and mixtures and derivatives thereof) all of which have an adequate number of unsaturated fatty acids (e.g., oleic, linolenic, linoleic) suitable for modification by esterification, epoxidation, or acylation. Note that, unless otherwise specified herein, percent (%) refers to weight percent.

Typically the unsaturated fatty acids are selected from the random mix of unsaturated fatty acids present in the vegetable oil. The saturated fatty acids are selected likewise from the random mix of saturated fatty acids present in the vegetable oil. The identifying portions of saturated fatty acids present are termed saturated acyl groups that are derived from saturated fatty acids and are typified by palmitoyl, stearoyl, arachidoyl, behenoyl, myristoyl, and margaroyl.

In some embodiments, the bioplasticizer is a modified soybean oil. The soybean oil may be modified by general steps of reacting fatty acids derived from vegetable oil with an alcohol (monool or polyol) to create ester linkages between the fatty acids and the alcohol by means of esterification, transesterification, or interesterification reactions, followed by epoxidation of the product of these esterification, transesterification, or interesterification reactions. Presumably, epoxidation increases the polarity and solubility parameter of the esterification, transesterification, or interesterification reaction products, resulting in increased compatibility of the vegetable-oil based plasticizer with polyvinyl chloride resin. Definitional descriptions of esterification reactions, transesterification reactions, interesterification reactions, and epoxidation reactions are provided below.

Esterification is defined as the reaction of a fatty acid (e.g., carboxylic acid) with an alcohol to produce an ester and water. These reactions are equilibrium reactions and are generally driven to completion by removal of water, typically by distillation if water is the lowest boiling component. This approach was used to create the ester linkages in the following preferred soybean oil-derived plasticizers: (i) epoxidized pentaerythritol tetrasoyate; (ii) epoxidized propylene glycol disoyate; and (iii) epoxidized ethylene glycol disoyate, discussed in greater detail below. The figure below illustrates a typical esterification reaction within the context of the present invention, wherein RCO₂H is a mixture of fatty acids derived from soybean oil by hydrolysis of soybean oil, and R′OH represents alcohol functions in pentaerythritol, propylene glycol, or ethylene glycol. [0027]

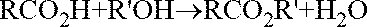

Transesterification is defined as the reaction of an ester with an alcohol to produce a derived ester and the alcohol in the original ester. These reactions are equilibrium reactions and are generally driven to completion by removal of the product alcohol, typically by distillation if this alcohol is the lowest boiling component. This approach was used to create ester linkages in the following preferred soybean oil-derived plasticizers: (i) epoxidized methyl soyate, and (ii) propylene glycol disoyate, the former discussed in greater detail below.

The figure below illustrates a typical transesterification reaction within the context of the present invention, wherein RCO₂R′ represents triglycerides derived from soybean or other vegetable oils, and R″OH represents pentaerythritol, propylene glycol, ethylene glycol, or methanol. [0030]

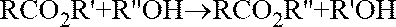

Interesterification involves reaction of two reactant esters to produce two product esters by interchange of original alcohol functions. Again, this reaction may be driven to completion by removal of one of the product esters, typically by distillation if one of the product ester is the lowest boiling component. Interesterification is used to prepare the ester linkages in the plasticizer sucrose octasoyate by the reaction of sucrose octaacetate and methyl soyate which also produces methyl acetate that is removed by distillation. Soybean oil was also interesterified with linseed oil (with a higher iodine value) to produce epoxidized, interesterified soybean oil. This interesterification process serves to increase the average number of double bonds in the modified triglyceride compared to those present in soybean oil. This significantly reduces the percentage of triglyceride molecules that have only zero, one, or two double bonds for subsequent epoxidation, thus leading to reduced migration, exudation, volatilization, and the like.

The figure below illustrates a typical interesterification reaction within the context of the present invention, wherein RCO₂R′ represents sucrose octaacetate and R″CO₂R‴ represents methyl soyate, or alternatively wherein RCO₂R′ represents soybean oil and R″CO₂R‴ represents linseed oil. [0033]

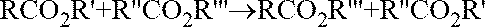

Interesterification of soybean oil with other vegetable oils results in complete randomization of all fatty acid groups present in a mixture of preferred vegetable oils. Thus, interesterification of soybean oil with a vegetable oil such as linseed oil or safflower oil, which have a higher percentage of highly unsaturated fatty acids (e.g., linolenic acid) than soybean oil, followed by epoxidation, decreases the percentage of non-epoxidized or minimally epoxidized ESO molecules. Presumably, it is these non-epoxidized or minimally epoxidized ESO molecules which are primarily responsible for exudation from PVC due their low solubility in or incompatibility with PVC.

In an alternative embodiment, interesterified oil is further reacted with alcohols (monools and polyols) by transesterification of the interesterified product, followed by epoxidation of the transesterified product.

Epoxidation is defined as the addition of an oxygen atom across a carbon-carbon double bond to create epoxide (or oxirane) functionality. Epoxidation reactions are typically performed with percarboxylic acids or other peroxy compounds. The figure below illustrates a typical epoxidation reaction within the context of the present invention, wherein R and R′ are alkyl, substituted alkyl or hydrogen, and R″ is aryl, substituted aryl, alkyl, or hydrogen.

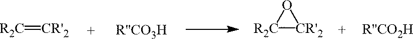

The bioplasticizers may fulfill a dual role as both the primary plasticizer and the thermal stabilizer. When the bioplasticizers are compounded with PVC resins at concentrations of above 15%, preferably above 20% and most preferably above about 30% of the matrix weight, these materials are effective primary plasticizers and thermal stabilizers. The upper limit of the soybean derived plasticizers is about 70% of the matrix weight. These materials, in combination with metal soaps, are highly effective as thermal stabilizers due to the high epoxide concentrations contributed by these materials.

In some embodiments, the bioplasticizer may include any of the following soybean oil-derived plasticizers: (i) epoxidized pentaerythritol tetrasoyate; (ii) epoxidized propylene glycol disoyate; (iii) epoxidized ethylene glycol disoyate; (iv) epoxidized methyl soyate; (v) epoxidized sucrose octasoyate; and (vi) the epoxidized product of soybean oil interesterified with linseed oil (epoxidized interesterified soybean oil).

According to further embodiments, the bioplasticizer may include hydrolysis products of the equivalent vegetable oil-derived plasticizers, equivalent to those listed immediately above, that are derived from vegetable oils having about the same or higher amounts of unsaturated double bonds. These equivalent vegetable oils include oils having iodine values above 100. Typically oils can vary greatly in iodine value, even within the same type of vegetable oil depending on the growing site of the oil. Typically oils harvested from plants grown in cooler sites will have more double bonds and thus higher iodine values than those grown in warmer regions such as the tropics or subtropics.

The bioplasticizer may be prepared by any conventional means, of which, the teachings of U.S. Pat. No. 6,797,753 (assigned to Battelle Memorial Institute, LLC) are provided as exemplary and are hereby incorporated by reference herein. An exemplary bioplasticizer for use in combination with a chlorinated ester to form a plasticizer composition of the present disclosure is reFlex™ 100 available from PolyOne.

In further embodiments, the bioplasticizer may include a bioester obtained by the partial transesterification of a mixture of vegetable oils or of one vegetable oil, such as soybean oil, with ethanol in a smaller ratio of vegetable oil to alcohol than that used for a complete transesterification reaction. After obtained, the mixture of mono and diglycerides resulting from the partial reaction are acetylated with acetic acid to reduce or eliminate the hydroxyl radicals. The mixture of acetylated mono and diglycerides, as well as the triglycerides and esters of the vegetable oil fatty acids are then epoxidized. The vegetable oils are chosen among the oils with an iodine value between 120 and 170, such as soybean oil, corn oil, linseed oil, sunflower oil, or a mixture of them.

The plasticizer composition obtained by the partial transesterification of vegetable oils with ethanol, acetylation and epoxidation presents a mixture of the following molecules (A), (B), (C), (D), (E), and/or (F):

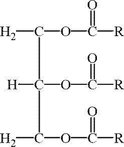

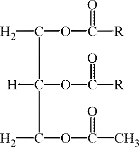

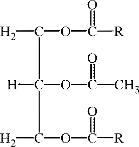

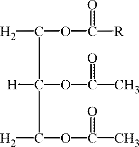

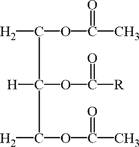

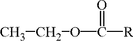

In molecules (A), (B), (C), (D), (E), and/or (F), R may be chosen randomly from the epoxidized oleic, linoleic and linolenic acids.

In another embodiment the bioplasticizer is obtained by the partial transesterification of a mixture of vegetable oils or one vegetable oil, such as soybean oil, with glycerin, under similar reaction conditions as those presented above. The vegetable oils are chosen among the oils with an iodine value between 120 and 170, such as soybean oil, corn oil, linseed oil, sunflower oil, or a mixture of them.

As mentioned above, the bioplasticizer may be prepared by any conventional means, of which, the teachings of United States Patent No. 8,623,947 are provided as exemplary and are hereby incorporated by reference herein. An exemplary bioplasticizer for use in combination with a chlorinated ester to form a plasticizer composition of the present disclosure is Innoleic™ E1 available from Innoleics Corporation.

In still further embodiments, the bioplasticizer may include a vicinally diacylated fatty acid ester. In some embodiments, the vicinally diacylated fatty acid esters are derived from vegetable oils. In one embodiment, the vicinally diacylated fatty acid ester of the invention may comprise fatty acids derived from vegetable oils. Suitable vegetable oils include soybean oil, palm oil, olive oil, cotton seed oil, linseed oil, safflower oil, sunflower oil, canola oil, rapeseed oil, j atropha oil, algae oil, tall oil, corn oil, tung oil, or mixtures of any two or more thereof. In specific embodiments, the oil may be soybean oil or linseed oil. In more specific embodiments, the oil is soybean oil.

In one embodiment, the vicinally diacylated fatty acid esters are derived from epoxidized vegetable oil. Suitable epoxidized vegetable oils include epoxidized soybean oil, epoxidized palm oil, epoxidized olive oil, epoxidized cotton seed oil, epoxidized linseed oil, epoxidized safflower oil, epoxidized sunflower oil, epoxidized canola oil, epoxidized rapeseed oil, epoxidized jatropha oil, epoxidized algae oil, epoxidized tall oil, epoxidized corn oil, epoxidized tung oil, or mixtures of any two or more thereof. Preferred are epoxidized soybean oil and epoxidized linseed oil. More preferred is epoxidized soybean oil.

In further embodiments, the vicinally diacylated fatty acid esters are derived from epoxidized fatty acids. Epoxidized fatty acids may be derived from epoxidized vegetable oils.

In embodiments, the vicinally diacylated fatty acid esters are derived from diols. In one embodiment, the vicinally diacylated fatty acid esters comprise fatty acids that are substantially fully esterified with diols. Exemplary diols employed in the substantially full esterification include, but are not limited to, ethylene glycol, 1,3-propanediol, propylene glycol, 1,4-butanediol, 1,6-hexanediol, and the like. Such vicinally diacylated fatty acid esters may have general formula (G) are provided.

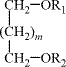

In formula (G), subscript m is 0, 1, 2, 3, or 4; and R₁ and R₂ are independently selected from any of formulas (G1), (G2), or (G3):

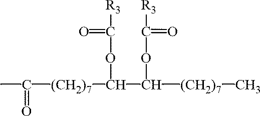

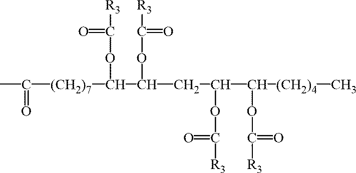

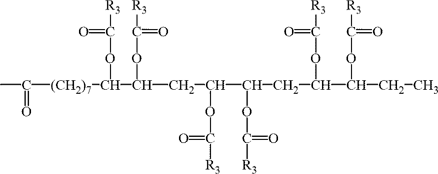

In formulas (G1), (G2), and (G3), R₃ and R₄ are independently selected from (C₁-C₈) alkyl, phenyl, or phenyl substituted by (C₁-C₈) alkyl.

Substantially full esterification of the vicinally diacylated fatty acid esters with diols may result in vicinally diacylated fatty acid diesters. Exemplary vicinally diacylated fatty acid diesters include vicinally diacylated stearic acid diesters. Preferred are vicinally diacetylated stearic acid diesters. More preferred are vicinally diacetylated stearic acid diesters of diols such as ethylene glycol, 1,3-propanediol, propylene glycol, 1,4-butanediol, 1,6-hexanediol.

In further embodiments, the vicinally diacylated fatty acid esters are derived from glycerol acetates. In one embodiment, the vicinally diacylated fatty acid esters comprise fatty acids that are substantially fully esterified with glycerol acetates. Suitable glycerol acetates are glycerol mono-acetate, glycerol di-acetate or mixtures thereof. The vicinally diacylated fatty acid esters may have general formula (H):

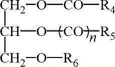

In formula (H), subscript n is 0 or 1; R₄ is (C₁-C₈) alkyl, phenyl, or phenyl substituted by (C₁-C₈) alkyl; and R₅, and R₆ are independently selected from any of formulas (G1), (G2), and (G3) as previously described and defined with respect to formula (G).

Substantially full esterification of vicinally diacylated fatty acid esters with glycerol acetates may form vicinally diacylated fatty acid glyceride acetates. Exemplary vicinally diacylated fatty acid glyceride acetates are vicinally diacylated fatty acid glyceride diacetates, vicinally diacylated fatty acid glyceride mono-acetates, or mixtures thereof. Preferred examples are vicinally diacetylated fatty acid monoglyceride diacetate, vicinally diacetylated fatty acid diglyceride mono-acetate, or mixtures thereof. More preferred are vicinally diacetylated stearic acid monoglyceride diacetate, vicinally diacetylated stearic acid diglyceride mono-acetate, or mixtures thereof.

As discussed above, the vicinally diacylated fatty acid esters may comprise fatty acids. Fatty acids may be saturated or comprise unsaturation. Suitable fatty acids comprising unsaturation are mono- or polyunsaturated fatty acids having 18 carbon atoms. Examples of these include oleic acid, linoleic acid, linolenic acid, ricinoleic acid, and dehydrated ricinoleic acid.

As mentioned above, the bioplasticizer may be prepared by any conventional means, of which, the teachings of United States Patent No. 8,507,596 (assigned to Galata Chemicals, LLC) are provided as exemplary and are hereby incorporated by reference herein. An exemplary bioplasticizer for use in combination with a chlorinated ester to form a plasticizer composition of the present disclosure is DRAPEX® Alpha 200 available from Galata Chemicals (Artek).

Additional bioplasticizers for use in combination with a chlorinated ester to form a plasticizer composition of the present disclosure include Biovero™ and VIKOFLEX® 2502, both of which are available from Cargill, Inc. Santicizer® Platinum G-2000, available from Valtris, may also be used in combination with a chlorinated ester to form a plasticizer composition of the present disclosure.

As previously described, the plasticizer composition includes the bioplasticizer and a chlorinated ester of a fatty acid. Having now described the bioplasticizer, the chlorinated ester of a fatty acid will now be described.

In embodiments, the chlorinated ester is represented by general formula (I):

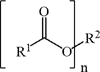

In formula (I), each R¹ is independently a (C₆-C₂₂) chlorinated hydrocarbyl; R² is a (C₁-C₁₈) hydrocarbon radical having a valence equal to subscript n; and subscript n is 1, 2, 3, or 4. The chlorinated hydrocarbyl R¹ may be a linear, branched, or cyclic hydrocarbon structure that is saturated or unsaturated, in which at least one hydrogen atom is substituted with a chlorine atom. In embodiments, the chlorinated hydrocarbyl R¹ may include from 1 to 2x + 1 chlorine substitutions, where x is the number of carbon atoms in the chlorinated hydrocarbyl R¹. In embodiments, the chlorinated hydrocarbyl R¹ includes two or fewer carbon-carbon double bonds in its primary chain of carbon atoms. In other embodiments, the chlorinated hydrocarbyl R¹ includes fewer than two carbon-carbon double bonds in its primary chain of carbon atoms. In other embodiments, the chlorinated hydrocarbyl R¹ is fully saturated and does not include any carbon-carbon double bonds.

In example embodiments, when subscript n is 1, the chlorinated ester has formula (Ia), in which R¹ and R² are as defined in formula (I):

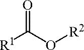

In example embodiments, the chlorinated ester is represented by the formula (Ia) wherein R² is a methyl group. In example embodiments, the chlorinated ester is represented by the formula (Ia) wherein R¹ is a (C₆-C₂₂) chlorinated hydrocarbyl comprising a primary chain of carbon atoms having less than two carbon-carbon double bonds, R² is a methyl group, and the chlorinated ester has chlorine content from 20% to 45% by weight.

In example embodiments, when subscript n is 2, the chlorinated ester has formula (Ib), in which R¹ and R² are as defined in formula (I):

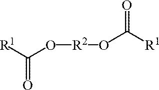

In the chlorinated ester according to formula (Ib), R² is a divalent hydrocarbon radical, substituted twice with esters

$$\left(- \text{OC} \left(\text{=O}\right) {\text{R}}^{1}\right) .$$

The individual ester substitutions may be on the same carbon atom of R² or, when R² has more than one carbon atom, on different carbon atoms of R².

In example embodiments, when subscript n is 3, the chlorinated ester has formula (Ic), in which R¹ and R² are as defined in formula (I):

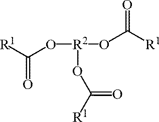

In the chlorinated ester according to formula (Ic), R² is a trivalent hydrocarbon radical, substituted three times with esters

$$\left(- \text{OC} \left(\text{=O}\right) {\text{R}}^{1}\right) .$$

The three individual ester substitutions may be on the same carbon atom of R². Alternately, one carbon atom may be twice substituted with esters and the third ester substitution is present on a different carbon atom. Alternately, the three ester substitutions may be on three different carbon atoms of R².

In example embodiments, when subscript n is 4, the chlorinated ester has formula (Id), in which R¹ and R² are as defined in formula (I):

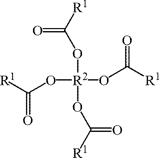

In the chlorinated ester according to formula (Id), R² is a tetravalent hydrocarbon radical, substituted four times with esters

$$\left(- \text{OC} \left(\text{=O}\right) {\text{R}}^{1}\right) .$$

The individual ester substitutions may be on the same carbon atom of R². Alternately, any one carbon atom of R² may be substituted three times with esters while a different carbon atom is substituted once with an ester; or any two carbon atoms of R² may be twice substituted with esters; or one carbon atom of R² may be twice substituted with esters while two different carbon atoms of R² are each substituted once with an ester; or four carbon atoms of R² each may be substituted once with an ester.

In example embodiments, the chlorinated ester according to formula (I), including chlorinated esters according to any of formulas (Ia), (Ib), (Ic), or (Id), may have a chlorine content of from 2% to 60%, or from 5% to 60%, or from 10% to 60%, or from 15% to 60%, or from 20% to 60%, or from 25% to 60%, or from 30% to 60%, or from 2% to 50%, or from 5% to 50%, or from 10% to 50%, or from 15% to 50%, or from 20% to 45%, or from 20% to 50%, or from 25% to 50%, or from 30% to 50%, or from 2% to 40%, or from 5% to 40%, or from 10% to 40%, or from 15% to 40%, or from 20% to 40%, or from 25% to 40%, or from 30% to 40%, or from 2% to 30%, or from 5% to 30%, or from 10% to 30%, or from 15% to 30%, or from 20% to 30%, or any subset of any of these ranges. In more specific embodiments, the chlorinated esters according to any of formulas (Ia), (Ib), (Ic), or (Id), may have a chlorine content of from 20% to 45%. Chlorine content is determined from the molecular structure of the chlorinated ester by dividing the portion of the molecular weight of the chlorinated ester attributed to chlorine atoms by the total molecular weight of the chlorinated ester, then multiplying by 100.

Without intent to be bound by theory, it is believed that a chlorine content above 45% for the chlorinated ester would result in the plasticizer composition no longer functioning as a plasticizer when mixed with a PVC resin to form a PVC compound. Moreover, it is believed that a chlorine content below 20% for the chlorinated ester would result in the plasticizer composition failing to demonstrate improved color hold for PVC materials produced using the plasticizer composition in combination with PVC resin.

The chlorinated esters may be prepared by any conventional means, of which, the teachings of United States Patent No. 9,963,572 are provided as exemplary and are hereby incorporated by reference herein. Exemplary chlorinated esters for use in combination with a bioplasticizer to form a plasticizer composition of the present disclosure include DOVERGUARD® E-35 and E-40, both available from Dover Chemical Corporation.

As previously described, the plasticizer composition includes the bioplasticizer in combination with the chlorinated ester of a fatty acid. The plasticizer compositions according to some embodiments may include from 30% to 99% by weight bioplasticizer and from 1% to 70% by weight chlorinated ester, based on the total weight of the plasticizer composition. The plasticizer compositions according to further embodiments may include from 50% to 99% by weight bioplasticizer and from 1% to 50% by weight chlorinated ester, based on the total weight of the plasticizer composition. In further embodiments, the plasticizer compositions may include from 75% to 95% by weight bioplasticizer and from 5% to 25% by weight chlorinated ester, based on the total weight of the plasticizer composition. In still further embodiments, the plasticizer compositions may include from 80% to 99% by weight bioplasticizer and from 1% to 20% by weight chlorinated ester, based on the total weight of the plasticizer composition.

Without intent to be bound by theory, it is believed that a plasticizer composition comprising less than 30% by weight bioplasticizer would cause compatibility issues in the PVC compound as well as loss of color improvement. Moreover, it is believed that a plasticizer composition comprising less than 1% by weight chlorinated ester would not achieve the desired improved color hold. As discussed earlier, bio-based plasticizers often lead to poor color hold in resulting PVC materials, especially when used as the sole primary plasticizer. Without intent to be bound by theory, it is believed that the addition of at least 1% by weight chlorinated ester reverses the negative color hold impact of a bioplasticizer when the two are combined and used as a plasticizer in PVC resin to produce PVC materials.

In the foregoing examples of plasticizer compositions, the plasticizer composition may consist of or consist essentially of the bioplasticizer and the chlorinated ester, or the plasticizer composition may include bioplasticizer and the chlorinated ester within the stated weight percent ranges relative to the total weight of the plasticizer composition and further include one or more additional ingredients.

In embodiments, the plasticizer composition is free from phthalates. In embodiments, the plasticizer composition is free from conventional plasticizers such as dioctyl terephthalate (DOTP) and diisononyl phthalate (DINP). As discussed above, conventional phthalate-based plasticizes such as DINP are often petroleum-derived and associated with harmful health effects. While DOTP is a non-phthalate plasticizer, its use as a plasticizer has raised health concerns as well. Accordingly, the plasticizers of the present disclosure avoid the environmental and potential health-related issues associated with conventional plasticizers while also being derived renewable bio-based materials. Moreover, PVC materials produced using the plasticizer compositions disclosed herein do not show poor color hold performance as typically associated with plasticized PVC materials produced using bio-based plasticizers.

Without intent to be bound by theory, it is believed that the combination of bioplasticizer and chlorinated ester in the plasticizer composition will improve compatibility of the bioplasticizer in finished PVC articles including the plasticizer composition and will allow for higher than typical loadings of bio-based ingredients such as, but not limited to, epoxidized soybean oil bioplasticizers, than are currently realized for finished PVC articles. In particular, it is recognized that the formulation of plasticizers with greater amounts of bio-based ingredients has been hindered by the tendency of bioplasticizers to separate from the finished PVC articles, owing to incompatibility of the bioplasticizers with the PVC polymer matrix. It is believed that inclusion of the chlorinated ester will not only reduce such incompatibility but, unexpectedly, will do so while also providing benefits such as heat resistance and less susceptibility to yellowing.

Further embodiments are directed to a composition including a polyvinyl chloride resin in combination with a plasticizer composition as previously described, optionally containing one or more additives as previously described. The composition may be described using the customary “phr” nomenclature, where “phr” means “parts [of component X] per hundred parts resin [polyvinyl chloride]. Thus, a composition that includes 50 phr plasticizer composition, in which 1000 grams of polyvinyl chloride is present, has a total mass of 1500 grams, namely 1000 grams of polyvinyl chloride and 500 grams of plasticizer composition.

In embodiments, the composition may be a flexible vinyl compound. In example embodiments, the flexible vinyl compound may include from 20 phr to 100 phr plasticizer composition, or from 20 phr to 90 phr plasticizer composition, or from 20 phr to 80 phr plasticizer composition, or from 30 phr to 70 phr plasticizer composition, or from 40 phr to 70 phr plasticizer composition, or from 50 phr to 70 phr plasticizer composition.

In further example embodiments, based on the chlorinated methyl ester component of the plasticizer composition alone, the flexible vinyl compound may include from 1 phr to 80 phr chlorinated methyl ester, from 10 phr to 80 phr chlorinated methyl ester, from 20 phr to 80 phr chlorinated methyl ester, or from 40 phr to 75 phr chlorinated methyl ester.

Further embodiments herein are directed to polyvinyl chloride articles prepared from the flexible vinyl compound including polyvinyl chloride, and the plasticizer composition, which includes the bioplasticizer as described herein in combination with the chlorinated ester of a fatty acid as described herein. The polyvinyl chloride articles may be prepared, for example, by combining polyvinyl chloride resin with a plasticizer composition as described herein to obtain a flexible vinyl compound; and subsequently fusing the flexible vinyl compound. The fusing step may be conducted according to any known method for fusing PVC flexible vinyl compounds.

In embodiments, the composition may be a plastisol. In example embodiments, the plastisol may include from 50 phr to 550 phr plasticizer composition, or from 50 phr to 70 phr plasticizer composition, or from 50 phr to 110 phr plasticizer composition, or from 70 phr to 500 phr plasticizer composition, or from 70 phr to 110 phr plasticizer composition, or from 110 phr to 350 phr plasticizer composition, or from 350 phr to 500 phr plasticizer composition.

In further example embodiments, based on the chlorinated ester component of the plasticizer composition alone, the plastisol may include from 1 phr to 80 phr chlorinated ester, from 10 phr to 80 phr chlorinated ester, from 20 phr to 80 phr chlorinated ester, or from 40 phr to 75 phr chlorinated ester.

As non-limiting examples, any of the commercial grade bioplasticizers disclosed herein may be used in combination with a chlorinated ester to form a suitable plastisol plasticizer. When combined with PVC resin, such plasticizers have shown promising results for the production of PVC materials from plastisols.

Further embodiments herein are directed to polyvinyl chloride articles prepared from the plastisol including polyvinyl chloride, and the plasticizer composition, which includes the bioplasticizer as described herein in combination with the chlorinated ester of a fatty acid as described herein. The polyvinyl chloride articles may be prepared, for example, by combining polyvinyl chloride resin with a plasticizer composition as described herein to obtain a plastisol, heating the plastisol to achieve plastisol gelation, and subsequently cooling the plastisol.

It should be understood by the skilled person that any of the compositions of the PVC materials described herein may be formulated, in addition to the above described plasticizer compositions, with various kinds of additives according to need. For example, additives that contribute to improvement of properties such as heat stability, lubricity, weathering resistance and the like, are exemplified by metal soaps such as calcium stearate, zinc stearate, lead stearate, barium stearate, cadmium stearate, tribasic lead sulfate, dibasic lead phosphite, organotin compounds such as dibutyltin dilaurate, dibutyltin dimaleate, di-n-octyltin mercaptide, dimethyltin mercaptide and the like as a stabilizer, and esters such as butyl stearate, aliphatic acid amides such as ethylene bistearamide, higher fatty acids such as stearic acid and polyethylene waxes as a lubricant, fillers, anti-oxidants, ultraviolet absorbers, anti-static agents, anti-fogging agent, pigments, dye-stuffs, and crosslinking aids.

### EXAMPLES

The following Examples are offered by way of illustration and are presented in a manner such that one skilled in the art should recognize are not meant to be limiting to the present disclosure as a whole or to the appended claims.

Example flexible vinyl compounds according to embodiments herein were prepared to assess color fastness characteristics of flexible vinyl compounds including the plasticizer compositions described herein with those of flexible vinyl compounds including a conventional dioctyl terephthalate (DOTP) plasticizer in combination with a limited amount of epoxidized soybean oil (ESO) to reduce phthalate content. One comparative sample (Example 1) was prepared, along with three test samples (Examples 2-4). The test samples included a chlorinated methyl ester in addition to the ESO, with no DOTP or other phthalate-based plasticizers. The resins prepared are summarized in Table 1.

TABLE 1

| | PVC Resin (pbw) | Stabilizer (pbw) | MS-60 (pbw) | Plasticizer (parts per hundred resin) | | | |
|---|---|---|---|---|---|---|---|
| | | | | DOTP | ESO | Bioplasticizer | C1 Ester-2 |
| Example 1 | 100 | 3 | 2 | 65 | 5 | - | - |
| Example 2 (Comparative) | 100 | 3 | 2 | - | 5 | 65 | - |
| Example 3 | 100 | 3 | 2 | - | 5 | 45 | 20 |
| Example 4 | 100 | 3 | 2 | - | 5 | 50 | 15 |
| Example 5 | 100 | 3 | 2 | 50 | 5 | - | 15 |
| Example 6 | 100 | 3 | 2 | 45 | 5 | - | 20 |

pbw = parts by weight
DOTP: dioctyl terephthalate
ESO: Epoxidized soybean oil
MS-60: Mineral Spirits flash point 60° C.
Bioplasticizer: Cargill VBP-2, a vegetable-based plasticizer based on soybean oil
Cl Ester-2: Dover E-35, a chlorinated methyl ester of a fatty acid

With the addition of significant amounts of chlorinated ester to the plasticizer compositions, it was expected that the resultant plastic materials would be highly prone to yellowing at processing temperatures, given the oxidizing nature of the chlorine substituents. Particularly, it was expected that the combination of ESO and chlorinated ester would be substantially more prone to yellowing than any composition including bioplasticizer alone as a plasticizer component. Unexpectedly, it was found that increasing the chlorinated ester actually imparted greater color hold at elevated temperatures when combined with the bioplasticizer.

In further analysis, 10-gram samples of each of the example compositions from Table 1 were heated at 190° C. in a convection oven for varying lengths of time, from 15 minutes to 120 minutes. The samples then were removed and permitted to cool. After cooling, each sample was analyzed with a HunterLab ColorQuest XE instrument to assess the La*b* color profile. In this color profile, the b* coordinate assesses a blue to yellow perception, where generally a lower b* number indicates bluishness and a higher b* number indicates yellowness.

TABLE 2

| Minutes | b* | | | | | |
|---|---|---|---|---|---|---|
| | Example 1 | Example 2 (Comparative) | Example 3 | Example 4 | Example 5 | Example 6 |
| 15 | 11.42 | 41.17 | 19.91 | 21.3 | 21.91 | Charred |
| 30 | 15.05 | 43.37 | 26.10 | 29.01 | Charred | Charred |
| 45 | 22.87 | 43.26 | 30.21 | 32.67 | Charred | Charred |
| 60 | Charred | 41.48 | 32.52 | 36.81 | Charred | Charred |
| 75 | Charred | 41.79 | 34.43 | 38.5 | Charred | Charred |
| 90 | Charred | 40.56 | 35.79 | 38.76 | Charred | Charred |
| 105 | Charred | 40.58 | 36.64 | 39.11 | Charred | Charred |
| 120 | Charred | 40.37 | 36.58 | 38.62 | Charred | Charred |

As is evident from the data in Table 2, the Example 1 combination of DOTP (synthetic phthalate replacement) plus ESO gives good early color hold, mid-term color hold and standard long term thermal heat stability (time to char) as compared to a phthalate plasticizer. The Example 2 composition including bioplasticizer and ESO showed the most yellowing in early and mid-term color hold but had extended long term heat stability. Examples 3 and 4 with a composition including bioplasticizer, ESO, and chlorinated ester showed substantially less yellowing than Example 2 in early and mid-term color hold while maintaining the extended long term heat stability. Example 5 and 6 compositions including DOTP, ESO, and chlorinated ester were more yellow than the composition of Example 1 and charred much faster.

Therefore, it is believed that a plasticizer composition including, in combination, an epoxidized bioplasticizer and a chlorinated ester, may exhibit desirable characteristics, even with high relative amounts of the chlorinate ester.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. The term “substantially” is used herein also to represent the degree by which a quantitative representation may vary from a stated reference without resulting in a change in the basic function of the subject matter at issue. Thus, it is used to represent the inherent degree of uncertainty that may be attributed to any quantitative comparison, value, measurement, or other representation, referring to an arrangement of elements or features that, while in theory would be expected to exhibit exact correspondence or behavior, may in practice embody something less than exact.

Unless otherwise defined, all technical and scientific terms used herein have the same meaning as commonly understood by one of ordinary skill in the art to which the invention belongs. The terminology used in the description herein is for describing particular embodiments only and is not intended to be limiting. As used in the specification and appended claims, the singular forms “a,” “an,” and “the” are intended to include the plural forms as well, unless the context clearly indicates otherwise.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” or “including” a second component, it is contemplated that, in some embodiments, the first component “consists” or “consists essentially of” the second component. Additionally, the term “consisting essentially of” is used in this disclosure to refer to quantitative values that do not materially affect the basic and novel characteristic(s) of the disclosure.

It should be understood that any two quantitative values assigned to a property or measurement may constitute a range of that property or measurement, and all combinations of ranges formed from all stated quantitative values of a given property or measurement are contemplated in this disclosure. Moreover, it should be understood that all ranges disclosed herein include all subranges and values therebetween.

While particular embodiments have been illustrated and described herein, it should be understood that various other changes and modifications may be made without departing from scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A plasticizer composition comprising, in combination:
from 30% to 99% by weight bioplasticizer based on the total weight of the plasticizer composition, the bioplasticizer comprising a vegetable-derived triglyceride or oil modified by esterification, epoxidation, or acylation; and
from 1% to 70% by weight chlorinated ester based on the total weight of the plasticizer composition, the chlorinated ester of a fatty acid, the chlorinated ester having a chlorine content from 2% to 60% by weight.

2. The plasticizer composition of claim 1, wherein the vegetable-derived triglyceride or oil is derived from soybean oil, palm oil, olive oil, cotton seed oil, linseed oil, safflower oil, sunflower oil, canola oil, rapeseed oil, jatropha oil, algae oil, tall oil, corn oil, tung oil, and mixtures of any two or more thereof.

3. The plasticizer composition of claim 1, wherein the bioplasticizer comprises an epoxidized soybean oil.

4. The plasticizer composition of claim 1, wherein the chlorinated ester is a compound according to formula (I): 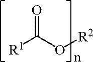
where:
each R¹ is independently a (C₆-C₂₂) chlorinated hydrocarbyl;
R² is a (C₁-C₁₈) hydrocarbon radical having a valence equal to subscript n; and subscript n is 1, 2, 3, or 4.

5. The plasticizer composition of claim 4, wherein n is 1.

6. The plasticizer composition of claim 5, wherein the hydrocarbon radical R² is a methyl group.

7. The plasticizer composition of claim 4, wherein the chlorinated hydrocarbyl R¹ comprises a primary chain of carbon atoms having less than two carbon-carbon double bonds.

8. The plasticizer composition of claim 4, wherein the chlorinated ester has a chlorine content from 20% to 45% by weight.

9. The plasticizer composition of claim 1, wherein the chlorinated ester is a compound according to formula (II): 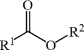
where:
R¹ is a (C₆-C₂₂) chlorinated hydrocarbyl comprising a primary chain of carbon atoms having less than two carbon-carbon double bonds;
R² is a methyl group; and
the chlorinated ester has a chlorine content from 20% to 45% by weight.

10. The plasticizer composition of claim 1, wherein the plasticizer composition is free from phthalates.

11. The plasticizer composition of claim 1, wherein the plasticizer composition is free from dioctyl terephthalate and diisononyl phthalate.

12. A composition comprising:
polyvinyl chloride; and
a plasticizer composition comprising, in combination:
from 30% to 99% by weight bioplasticizer based on the total weight of the plasticizer composition, the bioplasticizer comprising a vegetable-derived triglyceride or oil modified by esterification, epoxidation, or acylation; and
from 1% to 70% by weight chlorinated ester based on the total weight of the plasticizer composition, the chlorinated ester of a fatty acid, the chlorinated ester having a chlorine content from 2% to 60% by weight.

13. The composition of claim 12, wherein the chlorinated ester is a compound according to formula (II): 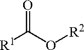
where:
R¹ is a (C₆-C₂₂) chlorinated hydrocarbyl comprising a primary chain of carbon atoms having less than two carbon-carbon double bonds;
R² is a methyl group; and
the chlorinated ester has a chlorine content from 20% to 45% by weight.

14. The composition of claim 12, wherein the composition is a plastisol having a minimum plasticizer composition content of 50 phr.

15. A polyvinyl chloride article prepared from the plastisol according to claim 14.

16. The composition of claim 12, wherein the composition is a flexible vinyl compound having a minimum plasticizer composition content of 20 phr.

17. A polyvinyl chloride article prepared from the flexible vinyl compound according to claim 16.

18. The composition of claim 12, wherein the composition is free from phthalates.

19. A method for preparing a polyvinyl chloride article, the method comprising:
combining polyvinyl chloride resin with a plasticizer composition to obtain a flexible vinyl compound, the plasticizer composition comprising, in combination:
from 30% to 99% by weight bioplasticizer based on the total weight of the plasticizer composition, the bioplasticizer comprising a vegetable-derived triglyceride or oil modified by esterification, epoxidation, or acylation; and
from 1% to 70% by weight chlorinated ester based on the total weight of the plasticizer composition, the chlorinated ester of a fatty acid, the chlorinated ester having a chlorine content from 2% to 60% by weight; and
fusing the flexible vinyl compound.

20. The method according to claim 19, wherein the chlorinated ester is a compound according to formula (II): 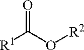
where:
R¹ is a (C₆-C₂₂) chlorinated hydrocarbyl comprising a primary chain of carbon atoms having less than two carbon-carbon double bonds;
R² is a methyl group; and
the chlorinated ester has a chlorine content from 20% to 45% by weight.
